(19) United States
(12) Patent Application Publication
(10) Pub. No.: US 2010/0129278 A1
(43) Pub. Date: May 27, 2010

(54) Continuous Process for Producing Titanium Tetrachloride Using On-Line Monitoring of Vanadium Oxytrichloride (VolcL3) With Anti-Fouling Management

(76) Inventors: Ling Zhou, Severna Park, MD (US); Frederick E. Schneider, Baltimore, MD (US); Rodney A. Hagins, Pasadena, MD (US)

Correspondence Address: DUNLAP CODDING, P.C. - MILLENNIUM, P.O. BOX 16370, OKLAHOMA CITY, OK, 73113, US

(21) Appl. No.: 12/466,788

(22) Filed: May 15, 2009

Related U.S. Application Data
(63) Continuation-in-part of application No. 11/491,335, filed on Jul. 21, 2006, now abandoned.

(51) Int. Cl. C01G 23/02

(52) U.S. Cl. 423/69

(57) ABSTRACT

An improved continuous process for producing titanium tetrachloride having a vanadium content of less than 5 ppm using on-line monitoring of vanadium oxytrichloride in crude titanium tetrachloride with effective anti-fouling management of precipitated niobium oxytrichloride.

### CROSS REFERENCE TO RELATED APPLICATIONS

This application is a Continuation-In-Part application of U.S. application Ser. No. 11/491,335, filed Jul. 21, 2006, now abandoned.

### BACKGROUND OF THE INVENTION

This invention relates to a continuous process for producing titanium tetrachloride having a vanadium content of less than 5 ppm, and, more particularly, this application relates to an improvement in such a process that is achieved by using on-line monitoring of vanadium oxytrichloride with effective anti-fouling management.

Titanium dioxide pigment is commercially produced by either the sulfate process or the chloride process. The chloride process first converts titania-containing ores (typically containing high concentrations of Ti0₂) to titanium tetrachloride via a carbochlorination reaction at a high temperature in the range of from 800° C. up to 1200° C. in a chlorinator in the presence of chlorine gas and petroleum coke added as a reductant. The chlorinator is typically a fluid-bed reactor, although static bed reactors have also be used.

The carbochlorination reaction produces titanium tetrachloride (TiCl₄) in addition to other metal chlorides, which may be volatile or non-volatile at the processing temperature. The vapor-phase (i.e., low boiling point) metal chlorides are separated from the waste non-volatile (i.e., high boiling point) metal chlorides, unreacted ore, and coke in a device such as a cyclone. The resulting vapor mixture is then condensed into a liquid phase crude titanium tetrachloride, which may contain other metal chlorides including aluminium trichloride (AlCl₃) and vanadium chloride or oxytrichloride (VOCl₃). Processes for removing aluminum chlorides and vanadium (oxy)chlorides are taught in, for example, U.S. Pat. Nos. 4,279,871 and 6,562,312 and PCT Int. Appl. WO 2004/063096.

Treatment agents are typically added to the crude titanium tetrachloride process stream in order to complex impurity metal chlorides which are then separated from the titanium tetrachloride by one or more distillation methods. Vanadium oxytrichloride, which has the closest boiling point to titanium tetrachloride, is then typically separated from the crude titanium tetrachloride by introducing a vanadium treatment agent into the process (such as an oil, ester, amine, activated carbon, hydrogen, hydrogen sulfide or a metal, such as iron or copper).

Particularly problematic has been accurate in-process monitoring of the vanadium oxytrichloride content in the crude TiCl₄ process stream to thereby control the rate of addition of the appropriate treatment agent, or passivating agent. Optical IR probes of the type most useful for in-process monitoring tend to become fouled after short periods of exposure to a crude TiCl₄ process stream. The problem is compounded when chlorine gas is injected into the chlorinator off-gas stream in response to detected high levels of ferrous chloride, as levels of vanadium oxytrichloride in the crude TiCl₄ process stream tend to increase, which, in turn, requires addition of more vanadium treatment agent.

The present invention provides an improvement in a continuous process for producing titanium tetrachloride having a vanadium content of less than 5 ppm using on-line, i.e., in-process, monitoring of vanadium oxytrichloride with effective anti-fouling management.

### BRIEF SUMMARY OF THE INVENTION

The present invention is an improvement in a continuous process for producing, or recovering, titanium tetrachloride from a crude titanium tetrachloride (TiCl₄) process stream where the process stream comprises a mixture of metal chlorides comprising titanium tetrachloride (TiCl₄), ferric chloride (FeCl₃), aluminum trichloride (AlCl₃), vanadium oxytrichloride (VOCl₃), and niobium oxytrichloride (NbOCl₃). The process is characterized by the basic steps of (a) contacting a titania-containing ore with chlorine gas at elevated temperature in one or more reaction zones in the presence of petroleum coke to produce a vapor phase off-gas stream; (b) condensing the vapor phase off-gas stream to produce a crude liquid phase; and (c) periodically injecting gaseous chlorine into the vapor phase off-gas stream in response to the concentration of ferrous chloride therein to react ferrous chloride to ferric chloride. The improvement comprises:
(i) establishing a recycle loop for recycling crude titanium tetrachloride;
(ii) passing a portion of the titanium tetrachloride process stream through the recycle loop;
(iii) placing a probe in the recycle loop capable of continuously sensing the concentration of oxychlorides in the crude titanium tetrachloride;
(iv) monitoring the concentration of vanadium oxytrichloride in the portion of crude titanium tetrachloride being passed through the recycle loop and introducing an amount of vanadium passivating agent into the crude titanium tetrachloride process stream in response to the monitored concentration of vanadium oxytrichloride;
(v) simultaneously monitoring the concentration of niobium oxytrichloride that precipitates on the probe in relation to a set point;
(vi) interrupting optionally up to 100% of the flow of said crude titanium tetrachloride from the recycle loop when the concentration of precipitated niobium oxytrichloride on the probe reaches the set point;
(vii) directing a flow of inert gas or a mixed flow of inert gas and crude titanium tetrachloride at elevated pressure in the range of from 20 psi up to 140 psi onto and/or across the optical IR probe with sufficient kinetic energy derived from the elevated pressure and flow rate of inert gas or mixed flow to sweep precipitated niobium ocytrichloride from the probe; and
(viii) isolating the flow of inert gas and renewing the flow of crude titanium tetrachloride through the recycle loop when the concentration of niobium oxytrichloride on the probe has dropped below the set point.
   In a preferred embodiment of the process improvement the inert gas is nitrogen.

The present invention provides more accurate and consistent on-line process control in the recovery of TiCl₄ from a crude TiCl₄ process stream whereby the amount of vanadium passivating agent consumed can be minimized and process economics improved.

### BRIEF DESCRIPTION OF THE DRAWINGS

FIG. 1 is a schematic diagram of a recycle loop for crude TiCl₄ according to the invention.

FIG. 2 is a sectional view of an optical IR probe positioned in the crude TiCl₄ recycle loop for monitoring oxychloride concentrations.

### DETAILED DESCRIPTION OF THE INVENTION

The present invention is an improvement in a continuous process for producing, or recovering, titanium tetrachloride from a crude titanium tetrachloride (TiCl₄) process stream. The crude titanium tetrachloride process stream is produced in the chloride process. The chloride process is well known in the art. See, for example, U.S. Pat. Nos. 2,486,912 and 2,701,179. The chlorination reaction produces a mixed chloride stream that comprises titanium tetrachloride (TiCl₄) in addition to other volatile and non-volatile metal chlorides. Following chlorination, the mixed chloride stream is cooled (typically to about 150° C.-450° C.) in a cooling vessel, such as a cyclone. Low-volatile metal chloride impurities (e.g., iron, manganese, magnesium, and chromium) are condensed in the cooling vessel and separated from the TiCl₄ vapor stream. The TiCl₄ vapor stream is then passed to one or more condensers where it is condensed to yield a crude liquid TiCl₄ process stream that can then be purified via distillation in one or more columns.

The crude titanium tetrachloride process stream is comprised of a majority of titanium tetrachloride that typically has a vanadium content of approximately 100-3000 ppm V (mainly vanadium oxytrichloride (VOCl₃)), based on the amount of titanium tetrachloride, and may additionally comprise aluminum, niobium, tantalum, and zirconium chlorides. Unreacted ore and coke fines may additionally be present as well. The crude titanium tetrachloride process stream also comprises aluminum trichloride, which has been observed to increase the rate of vanadium removal from the process, while simultaneously reducing the amount of vanadium treatment agent that is needed.

It is necessary to remove a majority of the vanadium oxytrichloride that is found in the crude titanium tetrachloride process stream in order to produce titanium tetrachloride that is useful for the production of titanium dioxide pigment of satisfactory quality. The presence of vanadium oxytrichloride is known to result in the formation of unwanted colored species in the titanium dioxide pigment product.

As a result of an increasing cost for obtaining high quality ores for TiO₂ production, producers have been using less expensive lower quality ores, such as slag and ilmenite. These raw materials contain higher percentages of impurities, e.g., iron, manganese, magnesium, and calcium, which have higher boiling points and exhibit a tendency to condense along the chlorinator outlet lines and form blockages that can interrupt production. To maintain normal production rates when processing lower quality ores, chlorine gas is injected into the chlorinator off-gas stream periodically to react ferrous chloride to ferric chloride and thereby keep the duct clean. Injection of chlorine gas results in a corresponding increase in vanadium concentration that creates a need for additional quantities of vanadium treatment agent as described below.

The crude titanium tetrachloride process stream is treated with a vanadium treatment agent that can be added into the crude titanium tetrachloride process stream by any suitable addition or mixing method. Although the process is not limited by choice of a particular vanadium treatment agent, suitable vanadium treatment agents include, but are not limited to, organic oils, esters, amines, activated carbon, and metal (e.g., Fe, Cu) or non-metal (e.g., H₂, H₂S) reductants. Preferred organic oils include petroleum oil, an animal fat, a vegetable oil, hydrogenated naphthenic oil (including severely hydrotreated heavy naphthenic distillate), and mixtures thereof. Particularly preferred organic oils include hydrogenated naphthenic oils, such as Hyprene® L 1200 (available from Ergon, Inc.). The amount of vanadium treatment agent needed is based on the amount necessary to reduce the vanadium content in purified titanium tetrachloride to less than 5 ppm. Typically, the amount of vanadium treatment agent consumed is in the range of from 0.8 to 1.2 times the stoichiometric quantity required to react with the vanadium oxytrichloride measured to be present in the crude process stream.

The vanadium treatment agent reacts with vanadium oxytrichloride to produce one or more easy-to-separate vanadium compounds. The easy-to-separate vanadium compounds are typically solids or other compounds that are much less volatile than titanium tetrachloride and are thus easy to separate by a variety of different processes. Separation processes include distillation, adsorption, filtration, decantation, centrifuge and the like.

The vanadium oxytrichloride content in the crude titanium tetrachloride process stream is measured in-process according to the invention by establishing a recycle loop for recycling a portion of the crude titanium tetrachloride and then placing a probe in the recycle loop that is capable of sensing the concentrations of oxychlorides in the process stream. The measurement can be performed by any convenient method, such as Transmission Filter Infrared Spectroscopy, Transmission Fourier Transform Infrared Spectroscopy, Raman Spectroscopy, Attenuated Total Reflectance Infrared Spectroscopy, or Attenuated Total Reflectance Fourier Transform Infrared Spectroscopy. From the foregoing measurement methods, Attenuated Total Reflectance Fourier Transform Infrared Spectroscopy has been found to produce consistent satisfactory results. The presence of vanadium oxytrichloride is detected by an adsorption band at about 1034 cm-¹ which correlates with the V═O stretching in VOCl₃. Based upon the amount of vanadium oxytrichloride detected according to the in-process measurement, the rate of addition of the vanadium treatment agent is then adjusted to maintain the vanadium content at an amount of less than 5 ppm vanadium based on the amount of titanium tetrachloride. For example, if the vanadium content in the process stream is measured at greater than 5 ppm, the amount of vanadium treatment agent can be increased to bring the vanadium content to less than 5 ppm. If the vanadium content in the process stream is measured at less than 5 ppm, the amount of vanadium treatment agent will be maintained (or may even be decreased) to maintain the vanadium content at less than 5 ppm. The in-process measurement and adjustment insures that vanadium treatment agent is used in only the quantity that is necessary to maintain the desired vanadium content.

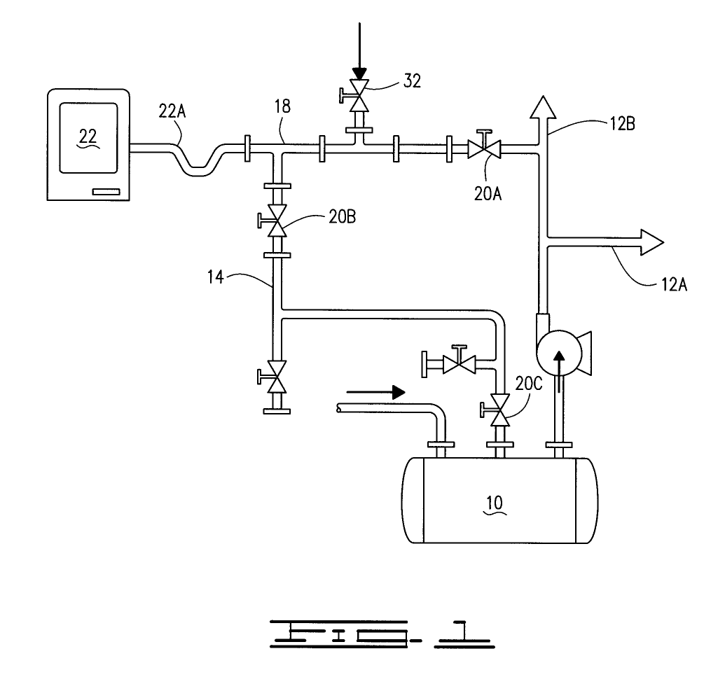

Referring now to the drawings, FIG. 1 is a schematic diagram of a recycle loop for crude TiCl₄ according to the invention shown in relation to a crude TiCl₄ storage tank. In the process for producing TiCl₄ of suitable quality for conversion to TiO₂, a crude TiCl₄ is first produced, and it may be collected in a storage tank 10 as shown. The crude TiCl₄ comprises a mixture of metal chlorides that includes titanium tetrachloride, ferric chloride, aluminum trichloride, vanadium oxytrichloride, and niobium oxytrichloride as well as other constituents. From storage tank 10 the crude TiCl₄ can be directed to other process equipment (not shown) using a pump 11, for example, via lines 12A and 12B to complete the refining portion of the process. To effectively monitor vanadium oxytrichloride and other oxychorides in the crude TiCl₄ process stream, a recycle loop 14 is established for recycling a portion of the crude TiCl₄ from the crude process stream back to storage tank 10. Although recycle loop 14 is shown in connection with a storage tank 10, the recycle loop 14 can be positioned in any convenient section of the process in which crude TiCl₄ is processed, keeping in mind that exact process conditions at any location may influence instrument response time. Furthermore, more than one such recycle loop 14 can be deployed in the process for more comprehensive system monitoring.

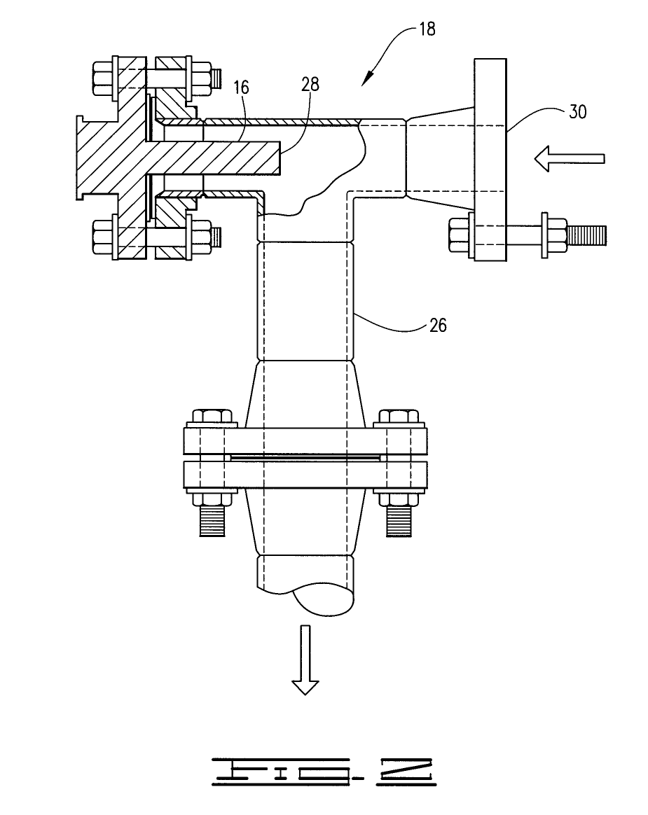

In the illustration shown, the recycle loop 14 includes an optical IR probe 16 (FIG. 2) preferentially positioned at a “Tee” location 18, although the optical probe 16 can be positioned in other locations within the recycle loop 14. Valves 20A, 20B, and 20C are positioned accordingly around the recycle loop 14 for isolating the loop from the crude TiCl₄ process stream as needed, including interrupting some or all of the crude TiO₄ passing through the recycle loop. Optical IR probe 16 is connected to an enclosed oxychloride analyzer 22 having a thermo-electric cooler and heaters for maintaining a constant internal enclosure temperature and a data collection computer with touch screen for storing data, generating data in real time as needed for process control, and monitoring the NbOCl₃ profile during cleaning.

A preferred oxychloride analyzer 22 for use according to the invention is a Mettler-Toledo MonARC (Monitoring All Reaction Chemistry) analyzer, although other analyzers having the same or similar functionality may also be used with good results. The MonARC analyzer is a FTIR instrument coupled with ATR (Attenuated Total Reflectance) wherein optical probe 16 has a diamond coated zinc selenide (ZnSe) window. A key feature is that the analyzer can monitor the whole mid IR region where vanadium and niobium oxychlorides can be detected simultaneously as well as any other constituents in the process stream which have an absorption band in the mid-IR region. The data collection parameters of the MonARC analyzer can be configured remotely by computer using a software tool know as the Remote Configuration Tool (RCT). The capability of the RCT allows a user to monitor the process, check diagnostics, view process variables, and event logs in near real-time, in addition to immediate data management. Analyzer 22 is interfaced to the sampling stream through a conduit 22A and the optical IR probe 16 as described in more detail below. The conduit requires a purge of dry, clean air or nitrogen.

Referring now to FIG. 2, there is shown a flanged “Tee” 26 having optical IR probe 16 installed in one leg of the Tee with the zinc selenide window 28 facing into the direction of flow. Tee 26 and the recycle loop comprise, for example, 2″ schedule 40 flanged piping of suitable materials of construction for the corrosive environment and crude TiCl₄ process stream being handled. A pipe size of 2″ was selected to allow for a gap of about 1″ between the optical IR probe outside diameter and the surface of the inner pipe wall to thereby avoid solids build-up around the probe. Although a pipe size of 2″ is used in this illustration, pipe sizes for the recycle loop can be smaller or larger, e.g., up to 4″ or 5″ in diameter. Tee 26 is mounted in the recycle loop whereby the optical IR probe 16 is positioned generally horizontally as shown with the probe window 28, i.e., the probe tip, facing into the direction of process flow, i.e., the flow of crude TiCl₄ enters inlet 30 such that it directly impinges against optical IR probe window 28. The optical IR probe window 28 can be positioned facing into the direction of flow as shown, or it can be positioned horizontally or vertically to be parallel to the process flow stream whereby the process stream passes across the optical IR probe window 28. In any configuration, however, it will be important to position the flow of inert gas to be generally perpendicular to the optical IR probe window.

Whatever configuration that may be selected, the assembly should provide for the optical IR probe 16 (and optical IR probe window 28) to extend into the process stream for a short distance, e.g., at least 0.25″ (6.35 mm). The horizontal position of Tee 26 was selected with a defined protrusion of optical IR probe 16 to assure sufficient flow turbulence at the probe tip where the optical IR window 28 is located.

In operating the recycle loop, valves 20A, 20B and 20C being open, crude TiO₄ continuously circulates past the optical IR probe window 28, and the presence of vanadium oxytrichloride is detected by the instrument recording an adsorption band at about 1034 cm⁻¹. Over time, NbOCl₃ tends to precipitate on the optical IR probe window 28 whereby the IR source becomes “blinded” to the crude TiCl₄ process stream. It was discovered that the NbOCl₃ absorption peak at 778 cm⁻¹ can be used as an indicator that the window 28 of the optical IR probe 16 was in need of cleaning.

Cleaning of the optical IR probe window 28 is conveniently accomplished by interrupting some (e.g., in the range of up to 75%) or all of the crude TiCl₄ stream flowing through the recycle loop 14 by adjusting or closing valve 20A and/or 20C accordingly. Valve 32 is then opened to allow a flow of nitrogen or other inert gas or dry air into the recycle loop 14 at an elevated pressure in the range of from 20 psi to 140 psi whereby the flow stream is directed generally perpendicular to the optical IR probe window 28, i.e., against the surface of the optical IR probe window 28. Inert gas by itself, or a mixture of inert gas with crude TiCl₄ already in the recycle loop, was observed to generate sufficient kinetic energy from the elevated pressure and corresponding turbulent flow to sweep, or clean, precipitated NbOCl₃ from the surface of the optical IR probe window 28. When the optical IR probe window 28 has been cleaned, as confirmed by a reduction in the niobium profile to a value below the set point, the flow of inert gas is then isolated by closing valve 32, and the flow of crude TiCl₄ through the recycle loop 14 is renewed.

The following examples illustrate the invention. Those skilled in the art will recognize many variations that are within the spirit of the invention and scope of the claims.

### Example 1

### Titanium Tetrachloride Purification Procedure

The effluent from a chlorinator reactor (50-60 wt % TiCl₄, 1000-3000 ppm VOCl₃, 40-50 wt % others, including impurity metal chlorides, unreacted ore and coke, and non-condensable gases) is cooled by passing the effluent into a cyclone. The chlorinator effluent is cooled to a temperature within a range of from 180° C.-300° C. The cyclone is cooled by a TiCl₄ spray. The solid and liquid waste (containing unreacted ore and coke, ferrous chloride, manganese chloride, magnesium chloride, and chromium chloride) is separated from the vapor product, and the vapor product is taken overhead in the cyclone and passed to a first stage quench tower maintained at a temperature of from 60° C.-90° C. The majority of TiCl₄ is condensed in the tower and passed to a surge tank (not shown). Any vapor phase TiCl₄ is passed to a second and third stage condenser which condenses the remaining TiCl₄ and passes it to a crude TiCl₄ tank 10. As the surge tank is filled, it overflows into the crude TiCl₄ tank 10. Vanadium treatment agent (Ergon, Inc., Hyprene® L 1200) is added to the surge tank. The presence of AlCl₃ will catalyze the reactions between vanadium compounds and the treatment agent, which results in faster reaction and less treatment agent requirement. At the same time, the reaction product between the vanadium compounds and the treatment agent partially or fully passivates AlCl₃ depending on the AlCl₃ and vanadium concentration in the crude TiCl₄. Unreacted AlCl₃, if any, along with NbCl₃, ZrCl₄, and TaCl₅ will then be passivated in the crude TiCl₄ tank 10 where H₂0/steam is added. The vanadium concentration is monitored on-line by FTIR using a recycle loop configured as shown in FIG. 1 according to the invention in each of the surge tank and the crude TiCl₄ tank 10. Adjustment for vanadium treatment agent amount in the surge tank will be based on the recorded vanadium concentration. A further vanadium treatment agent addition can be made at a convenient location downstream in the process if ever the situation arises.

### Example 2

An upper limit for niobium oxytrichloride in refined TiCl₄ was set at 5 ppm in the plant digital control system. A flashing “clean the probe” command was set to appear on the computer screen in the control room when the niobium upper limit is reached. As soon as the “clean the probe” command was observed, an operator closed from 50% to 100% of the crude TiCl₄ flow passing through valve 20A (FIG. 1) and then opened a flow of inert gas through valve 32 for a period of from 1-2 minutes. Valve 32 was then closed and valve 20A was opened to return normal flow of crude TiCl₄ through the recycle loop. The cleaning process was accomplished successfully when the niobium profile was observed to drop to the desired level as seen on the touch screen computer located on the MonARC analyzer in the field. The procedure can be repeated as needed, and it can be automated by installing automatic control valves at the crude titanium tetrachloride inlet valve 20A and inert gas inlet valve 32 as well as an algorithm (stored on a computer readable meadium) that causes a computer processor within the analyzer 22 or external thereto to compare the data being generated by the optical IR probe 16 in relation to a set point and to control the titanium tetrachloride inlet valve 20A and inert gas inlet valve 32 to periodically clean the window 28 of the optical IR probe 16 when the detected amount of niobium oxytrichloride reaches or comes with a predetermined value in relation to the set point.

Changes may be made in the construction and operation of the various components, elements and assemblies described herein, and changes may be made in the steps or the sequence of steps of the methods described herein, without departing from the spirit and scope of the invention as defined in the following claims.

1. In a continuous process for recovering titanium tetrachloride from a crude titanium tetrachloride process stream comprising a mixture of metal chlorides comprising titanium tetrachloride, ferrous chloride, aluminum trichloride, vanadium oxytrichloride, and niobium oxytrichloride of the type wherein:
(a) a titania-containing ore is contacted with chlorine gas at elevated temperature in one or more reaction zones in the presence of petroleum coke to produce a vapor phase off-gas stream;
(b) said vapor phase off-gas stream is condensed to produce a crude liquid phase; and
(c) gaseous chlorine is injected into the vapor phase off-gas stream in response to the concentration of ferrous chloride in said off-gas stream;
the improvement comprising:
(i) establishing a recycle loop for recycling a portion of said crude titanium tetrachloride process stream;
(ii) passing a portion of said crude titanium tetrachloride through said recycle loop;
(iii) placing a probe in said recycle loop capable of continuously sensing the concentration of oxychlorides in said crude titanium tetrachloride;
(iv) monitoring the concentration of vanadium oxytrichloride in said crude titanium tetrachloride and introducing an amount of vanadium passivating agent into said crude titanium tetrachloride process stream in response to said monitored concentration of vanadium oxytrichloride;
(v) simultaneously monitoring the concentration of niobium oxytrichloride that precipitates on the probe in relation to a set point;
(vi) interrupting up to 100% of the flow of said crude titanium tetrachloride from said recycle loop when the concentration of niobium oxytrichloride on the probes reaches the set point;
(vii) directing a flow of inert gas or a mixed flow of inert gas and titanium tetrachloride at elevated pressure in the range of from 20 psi up to 140 psi onto the probe with sufficient kinetic energy derived from the elevated pressure and flow rate to sweep precipitated niobium ocytrichloride from the probe;
(viii) isolating the flow of inert gas and renewing the flow of crude titanium tetrachloride through the recycle loop when the concentration of niobium oxytrichloride on the probe has dropped below the set point.

2. The process of claim 1 wherein the inert gas is nitrogen or dry air.

3. The process of claim 2 wherein the probe is an optical IR probe comprising a zinc selenide window, and the flow of inert gas is directed generally perpendicular to the zinc selenide window.

4. The process of claim 4 wherein simultaneously monitoring the concentration of vanadium oxytrichloride and niobium oxytrichloride is accomplished with a method selected from Transmission Filter Infrared Spectroscopy, Transmission Fourier Transform Infrared Spectroscopy, Raman Spectroscopy, Attenuated Total Reflectance Infrared Spectroscopy, or Attenuated Total Reflectance Fourier Transform Infrared Spectroscopy.

5. The process of claim 5 wherein the method is Attenuated Total Reflectance Fourier Transform Infrared Spectroscopy.
